(19) United States
(12) Patent Application Publication
(10) Pub. No.: US 2015/0303974 A1
(43) Pub. Date: Oct. 22, 2015

(54) Independent Multi-Band Tuning

(71) Applicant: SKYWORKS SOLUTIONS, INC., Woburn, MA (US)

(72) Inventor: William J. Domino, Yorba Linda, CA (US)

(21) Appl. No.: 14/683,473

(22) Filed: Apr. 10, 2015

Related U.S. Application Data
(60) Provisional application No. 61/981,688, filed on Apr. 18, 2014.

(51) Int. Cl. H04B 1/401; H04B 1/52; H04L 5/08

(52) U.S. Cl. CPC H04B 1/401; H04L 5/08; H04B 1/52; H04W 88/06

(57) ABSTRACT

Various implementations include circuits, devices and/or methods that enable tuning a multi-band antenna such that two or more of the bands are tuned independently of one another, whereby tuning one band is decoupled from tuning another band. Some implementations include a multi-band tuning arrangement having first and second tunable two-terminal circuits. The first tunable two-terminal circuit has a low transmission impedance associated with a first frequency band, and a high transmission impedance associated with a second frequency band, the first tunable two-terminal circuit including a first control element to selectively adjust a first resonant frequency associated with the first frequency band. The second tunable two-terminal circuit having a high transmission impedance associated with the first frequency band, and a low transmission impedance associated with the second frequency band, the second tunable circuit including a second control element provided to adjust a second resonant frequency associated with the second frequency band.

### RELATED APPLICATIONS

This application claims the benefit of U.S. Provisional Patent Application No. 61/981,688, filed on Apr. 18, 2014, and which is incorporated by reference herein.

### TECHNICAL FIELD

The present disclosure relates to wireless communication systems, and in particular, to antenna tuning arrangements suitable for multi-band wireless devices.

### BACKGROUND

Wireless communication systems are widely deployed to provide various types of communication content such as voice, data, and multimedia applications and services. These systems are typically configured to support communication with multiple users by sharing available system resources, such as designated portions of frequency spectrum. The ongoing popularity of high data-rate wireless services continues to spur demand for access to available frequency spectrum. The ability to satisfy the demand is often limited by a lack of available frequency spectrum that may be shared for reliable communications within a geographic area.

Various spectrum access techniques have been developed that allow users within a geographic area to share access to available frequency bands designated for wireless communication. For example, previously available user devices, such as smartphones and tablet computing devices, are capable of selecting one of multiple frequency bands that may be available. For example, 3G cellular multimode, multiband devices can operate in three to four bands designated by 2.5G EDGE/GSM standards and another three to four bands designated by the 3G WCDMA/HSPA standards. In some deployments, 3GPP Long Term Evolution (LTE) and LTE-Advanced standards may support as many as eleven frequency bands.

However, previously available tuning circuits are incapable of tuning a multi-band antenna so that two or more of the bands are tuned independently of one another. As such, tuning performed in one band impacts the other bands. As a practical matter, it is highly unlikely that the amount of tuning used in one band is substantially the same as the amount of tuning used in another band. As such, previously available devices are restricted to selecting and using one band at a time, even though multiple bands are available to a device.

### SUMMARY

Various implementations of circuits, methods and devices within the scope of the appended claims each have several aspects, no single one of which is solely responsible for the attributes described herein. Without limiting the scope of the appended claims, some prominent features are described. After considering this disclosure, and particularly after considering the section entitled “Detailed Description,” one will understand how the aspects of various implementations enable tuning a multi-band antenna so that two or more of the bands are tuned independently of one another, whereby tuning in one band is substantially decoupled from tuning in another band.

Some implementations include a multi-band tuning arrangement configured to enable tuning in one band to be substantially decoupled from tuning in another band. In some implementations, the multi-band tuning arrangement includes a first tunable two-terminal circuit, and a second tunable two-terminal circuit. The first tunable two-terminal circuit having a low transmission impedance associated with a first frequency band, and a high transmission impedance associated with a second frequency band, the first tunable two-terminal circuit including a first control element provided to selectively adjust a first resonant frequency associated with the first frequency band. The second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

Some implementations include a multi-band tuning module configured to enable tuning in one band to be substantially decoupled from tuning in another band. In some implementations, the multi-band tuning module includes a packaging substrate configured to receive a plurality of components, a first tunable two-terminal circuit at least partially arranged on the packaging substrate connectable between a first transceiver port and an antenna port, and a second tunable two-terminal circuit at least partially arranged on the packing substrate connectable between a second transceiver port and the antenna port. The first tunable two-terminal circuit having a low transmission impedance associated with a first frequency band, and a high transmission impedance associated with a second frequency band, the first tunable two-terminal circuit including a first control element provided to selectively adjust a first resonant frequency associated with the first frequency band. The second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

Some implementations include a wireless device configured to enable tuning in one band to be substantially decoupled from tuning in another band. In some implementations, the wireless device includes a multi-band antenna configured to transmit and receive radio frequency signals in a plurality of disjoint portions of frequency spectrum; a first transceiver configured to at least one of transmit and receive radio frequency signals in a first frequency band of the plurality of disjoint portions of frequency spectrum; a second transceiver configured to at least one of transmit and receive radio frequency signals in a second frequency band of the plurality of disjoint portions of frequency spectrum; a first tunable two-terminal circuit having a low transmission impedance associated with the first frequency band, and a high transmission impedance associated with the second frequency band, the first tunable two-terminal circuit including a first control element provided to selectively adjust a first resonant frequency associated with the first frequency band; and a second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of a portion of a wireless device including a tuning arrangement and low-band/high-band (LB/HB) switch.

FIG. 2 is a performance diagram illustrating simultaneous and highly correlated tuning on two transmission bands provided by a tuning arrangement.

FIG. 3 is a block diagram of a portion of a wireless device including a dual band antenna tuner arrangement in accordance with some implementations.

FIG. 4 is a performance diagram illustrating independently tunable transmission bands enabled by a dual band antenna tuner in accordance with some implementations.

FIG. 5 is a schematic diagram of a series dual band antenna tuner arrangement in accordance with some implementations.

FIG. 6A is a performance diagram showing complementary impedance poles and zeros of a dual band antenna tuner arrangement in accordance with some implementations.

FIG. 6B is a performance diagram showing complementary impedance poles and zeros of a dual band antenna tuner arrangement in accordance with some implementations.

FIG. 7 is a schematic diagram of a shunt dual band antenna tuner arrangement in accordance with some implementations.

FIG. 8 is a block diagram of a dual band antenna tuner arrangement in accordance with some implementations.

FIG. 9 is a block diagram of a dual band antenna tuner system in accordance with some implementations.

FIGS. 10A-10C are schematic diagrams of integrated circuits including a dual band antenna tuner in accordance with some implementations.

FIG. 11 is a schematic diagram of a module including a dual band antenna tuner in accordance with some implementations.

In accordance with common practice various features shown in the drawings may not be drawn to scale, as the dimensions of various features may be arbitrarily expanded or reduced for clarity. Moreover, the drawings may not depict all of the aspects and/or variants of a given system, method or apparatus admitted by the specification. Finally, like reference numerals are used to denote like features throughout the figures.

### DESCRIPTION

Numerous details are described herein in order to provide a thorough understanding of the example implementations illustrated in the accompanying drawings. However, the invention may be practiced without many of the specific details. Well-known methods, components, and circuits have not been described in exhaustive detail so as not to unnecessarily obscure more pertinent aspects of the implementations described herein.

An antenna of a wireless device is used to transmit and receive radio frequency (RF) signals in a frequency band. A tuner circuit is often used to enable adjustable impedance matching between a transceiver and an antenna at selectable frequencies. Tuning typically refers to adjusting a primary resonant frequency of a component or a frequency dependent value (e.g., impedance) is relation to the center frequency of a RF signal. More specifically, a tuner circuit is typically used to provide an impedance match at the carrier frequency of a RF signal in order to improve power transfer between the transceiver and the antenna at the carrier frequency of the RF signal. The impedance match provided by a tuner circuit typically satisfies a performance threshold throughout a frequency range around the carrier frequency of the RF signal, known as the transmission band. The result of tuning is typically a frequency shift (Δf) of the entire transmission band in one direction or the other.

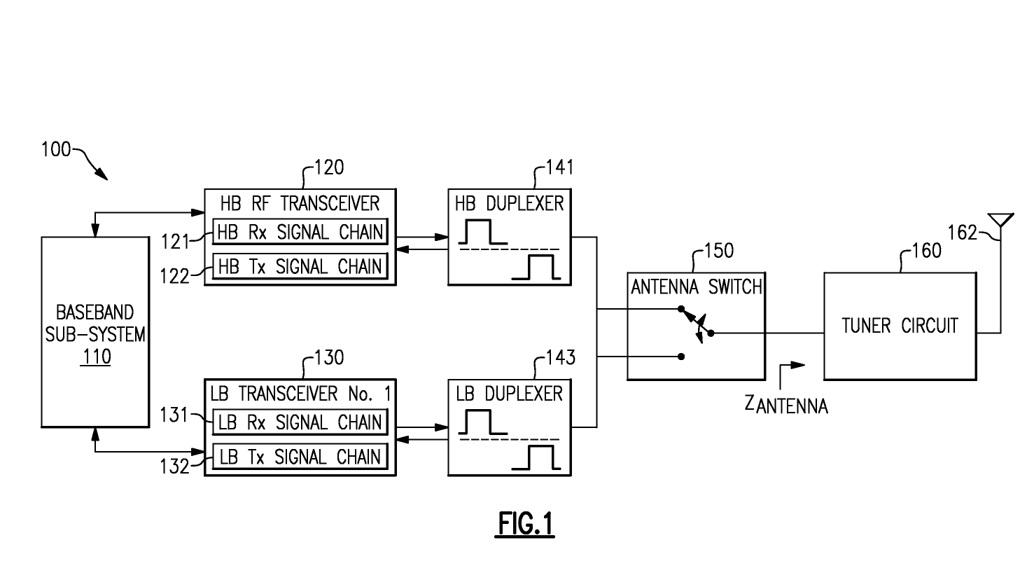

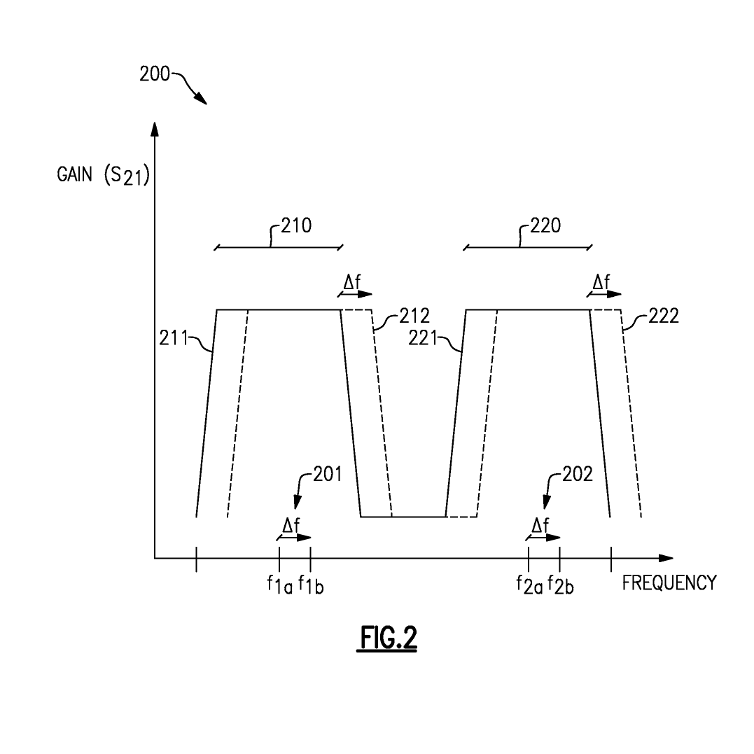

Multi-band antennas provide two or more frequency bands in which RF signals can be transmitted and received. However, as described in greater detail below with reference to FIGS. 1 and 2, previously available tuner circuits are incapable of tuning a multi-band antenna so that a respective impedance match provided in one band is tuned independently of a respective impedance match provided in another band. As a result, tuning in one band using a previously available tuner circuit results in a simultaneous frequency shift (Δf) of two or more corresponding transmission bands. In turn, the simultaneous use of the two or more bands provided by a multi-band antenna is not generally possible. Consequently, previously available devices utilizing multi-band antennas are restricted to selecting and using one band at a time, or, operating in both band with excess signal loss in each band.

FIG. 1 is a block diagram of a portion of a wireless device 100. While certain specific features are illustrated, those skilled in the art will appreciate from the present disclosure that various other features have not been illustrated for the sake of brevity and so as not to obscure more pertinent aspects of the example implementations disclosed herein. To that end, the wireless device 100 includes a baseband sub-system 110, a high-band (HB) RF transceiver 120, a HB duplexer 141, a low-band (LB) RF transceiver 130, a LB duplexer 143, an antenna switch 150, a tuner circuit 160 and an antenna 162.

The tuner circuit 160 is coupled between the antenna 162 and the antenna switch 150, and is configured to enable adjustable impedance matching between the antenna 162 and the remainder of the wireless device 100 at selectable frequencies. In other words, the tuner circuit 150 is operable to set and present an antenna load impedance (Zₐₙₜₑₙₙₐ) to the remainder of the wireless device 100.

The HB RF transceiver 120 and the HB duplexer 141 are coupled in series between the baseband sub-system 110 and the antenna switch 150, and thus form a HB transmission signal path within the wireless device 100. The HB RF transceiver 120 includes a HB transmit signal chain 122 and a HB receive signal chain 121. In some implementations, the HB transmit signal chain 122 is configured to up-convert a modulated signal received from the baseband sub-system 110 to a carrier frequency within a high-band portion of frequency spectrum accessible by the antenna 162. In some implementations, the HB receive signal chain 121 is configured to down-convert a modulated signal received in the high-band, and provide the down-converted signal to baseband sub-system 110. The HB duplexer 141 is configured to provide frequency domain isolation between transmitted HB RF signals and received HB RF signals so that the HB transmit signal chain 122 and the HB receive signal chain 121 can be used simultaneously.

Similarly, the LB RF transceiver 130 and the LB duplexer 143 are coupled in series between the baseband sub-system 110 and the antenna switch 150, and thus form a LB transmission signal path within the wireless device 100. The LB RF transceiver 130 includes a LB transmit signal chain 132 and a LB receive signal chain 131. In some implementations, the LB transmit signal chain 132 is configured to up-convert a modulated signal received from the baseband sub-system 110 to a carrier frequency within a low-band portion of frequency spectrum accessible by the antenna 162. In some implementations, the LB receive signal chain 131 is configured to down-convert a modulated signal received in the low-band, and provide the down-converted signal to baseband sub-system 110. The LB duplexer 143 is configured to provide frequency domain isolation between transmitted LB RF signals and received LB RF signals so that the LB transmit signal chain 132 and the LB receive signal chain 131 can be used simultaneously.

The antenna switch 150 is configured to select and couple one of the HB and LB transmission signal paths for use with the antenna 162, so that a previously available tuner circuit can be utilized. Without the antenna switch 150, operation of a previously available tuner circuit would result in tuning in one band (e.g., the high-band) that affects the second band (e.g., the low-band), making the second band unreliable for communication.

FIG. 2 is a performance diagram 200 illustrating simultaneous and correlated tuning on two transmission bands provided by a previously available tuner circuit. More specifically, FIG. 2 illustrates an approximation of forward transmission coefficient (i.e., s-parameter s21) performance in the frequency domain of a dual-band antenna paired with a previously available tuner circuit. The tuner circuit and the dual-band antenna establish first and second transmission bands 210, 220 defined by the forward transmission coefficient performance. Moreover, those of ordinary skill in the art will appreciate that while tuning has been described as a passband shift for the sake of illustration, more generally tuning is often considered achieving an impedance match in a desired band.

The first transmission band 210 is located at a respective first position 211 around a corresponding first center frequency f₁ₐ. Similarly, the second transmission band 220 is located at a respective first position 221 around a corresponding first center frequency f₂ₐ. As noted above, previously available tuner circuits are incapable of tuning a multi-band antenna so that a respective impedance match provided in one band (e.g., band 210) is tuned independently of a respective impedance match provided in another band (e.g., band 220). As a result, tuning the first transmission band 210 from the first position 211 to a second position 212 by a frequency shift (Δf) 201, using a previously available tuner circuit, results in a simultaneous frequency shift (Δf) 202 of the second transmission band 220 from its first position 221 to a corresponding second position 222. The frequency shifts 201 and 202 occur in the same direction along the frequency axis, are highly correlated, and are typically about the same magnitude. In other words, the respective first center frequencies f₁ₐ, f₂ₐ of the bands 210, 220 shift to corresponding second center frequencies f_{1b}, f_{2b} by substantially equal unidirectional frequency offsets Δf. As a practical matter in a communication system, it is highly unlikely that the amount of tuning useful in one band will be substantially the same as the amount of tuning useful in another band. Consequently, the simultaneous use of the two or more bands provided by a multi-band antenna is not generally possible. In turn, previously available devices utilizing multi-band antennas are restricted to selecting and using one band at a time, using an antenna switch or the like in order to pair transceivers with individual frequency bands, else there will be excess signal loss in one or both bands. In other words, previously available tuner circuits substantially prevent the simultaneous use of two frequency bands accessible (without excessive signal loss) by one multi-band antenna.

The various implementations described herein include devices, arrangements and methods that enable independently tuning one or more transmission bands associated with a multiband antenna. Numerous details are described herein in order to provide a thorough understanding of the example implementations illustrated in the accompanying drawings. However, the invention may be practiced without many of the specific details. Well-known methods, components, and circuits have not been described in exhaustive detail so as not to unnecessarily obscure more pertinent aspects of the implementations described herein.

For example, some implementation include a multi-band antenna tuning arrangement including at least a first tunable two-terminal circuit and a second tunable two-terminal circuit. The first tunable two-terminal circuit includes a low transmission impedance associated with a first frequency band, and a high transmission impedance associated with a second frequency band. The first tunable two-terminal circuit also includes a first control element provided to selectively adjust a first resonant frequency associated with the first frequency band. Similarly, the second tunable two-terminal circuit includes a high transmission impedance associated with the first frequency band, and a low transmission impedance associated with the second frequency band. The second tunable two-terminal circuit also includes a second control element provided to selectively adjust a second resonant frequency associated with the second frequency band.

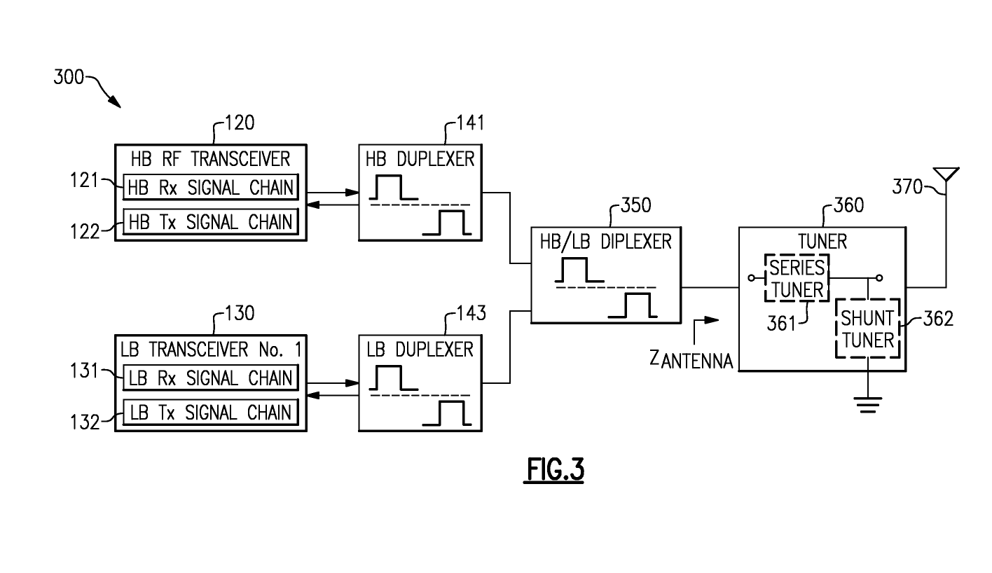

FIG. 3 is a block diagram of a portion of a wireless device 300 including a dual-band antenna tuner circuit 360 in accordance with some implementations. The wireless device 300 illustrated in FIG. 3 is similar to and adapted from the wireless device 100 illustrated in FIG. 1. Elements common to both implementations include common reference numbers, and only the differences between FIG. 3 and FIG. 1 are described herein for the sake of brevity. While certain specific features are illustrated, those skilled in the art will appreciate from the present disclosure that various other features have not been illustrated for the sake of brevity and so as not to obscure more pertinent aspects of the example implementations disclosed herein.

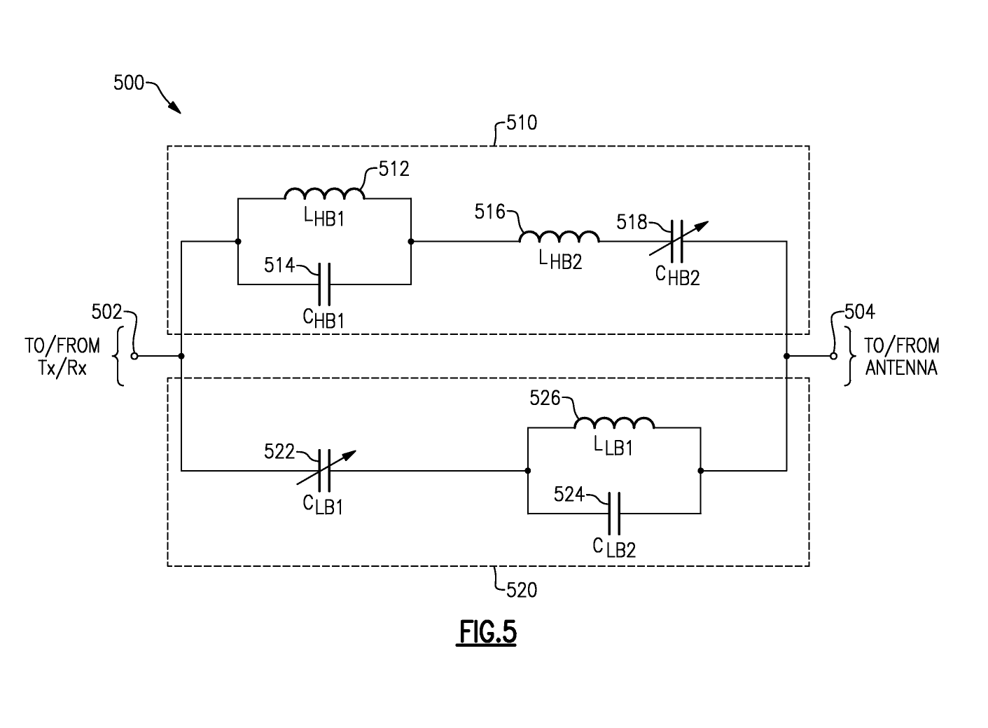

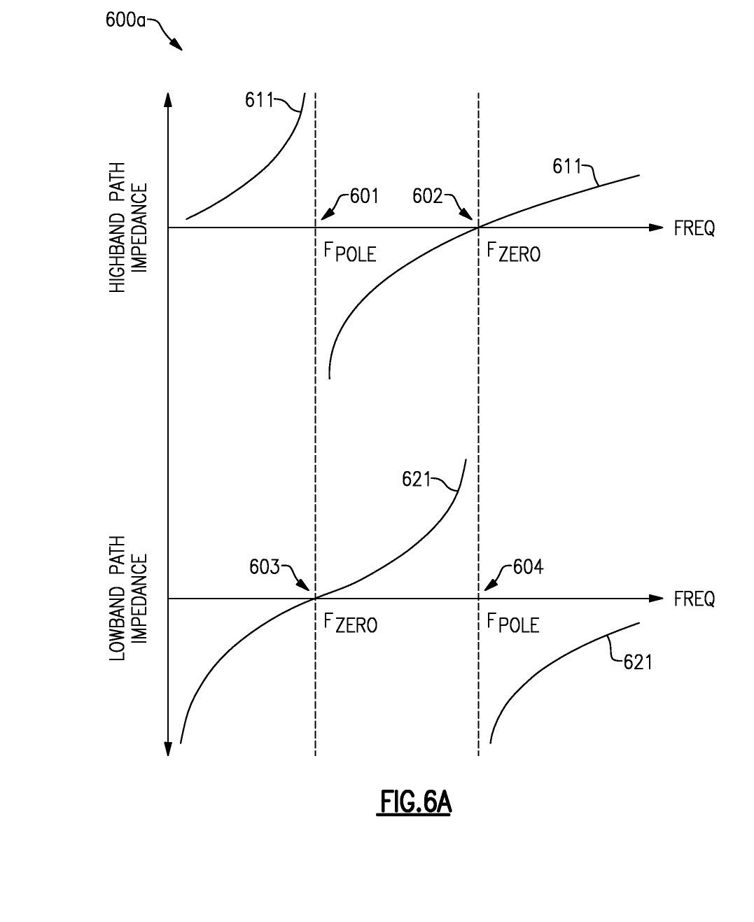

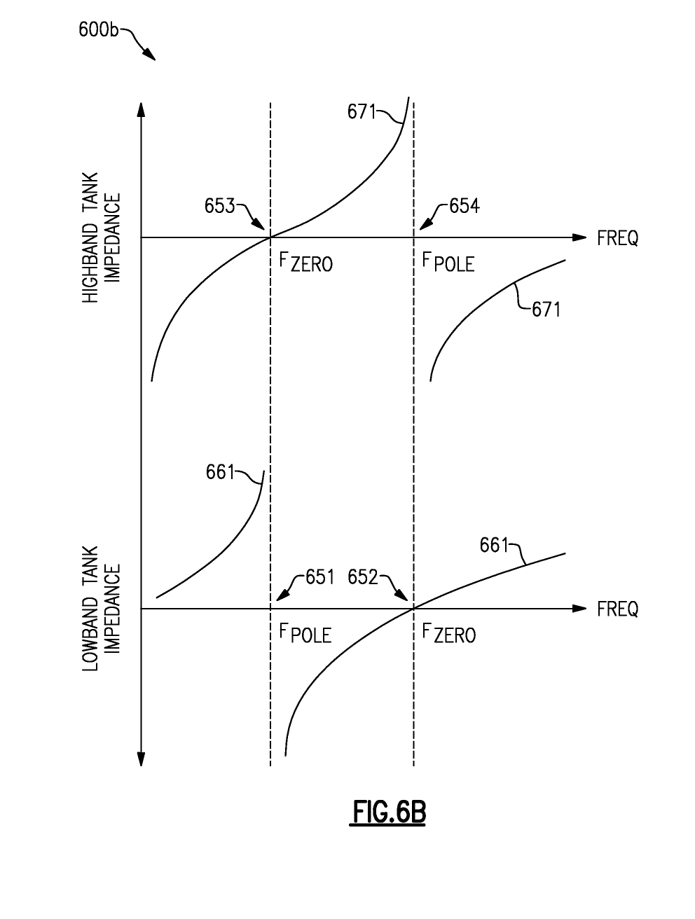

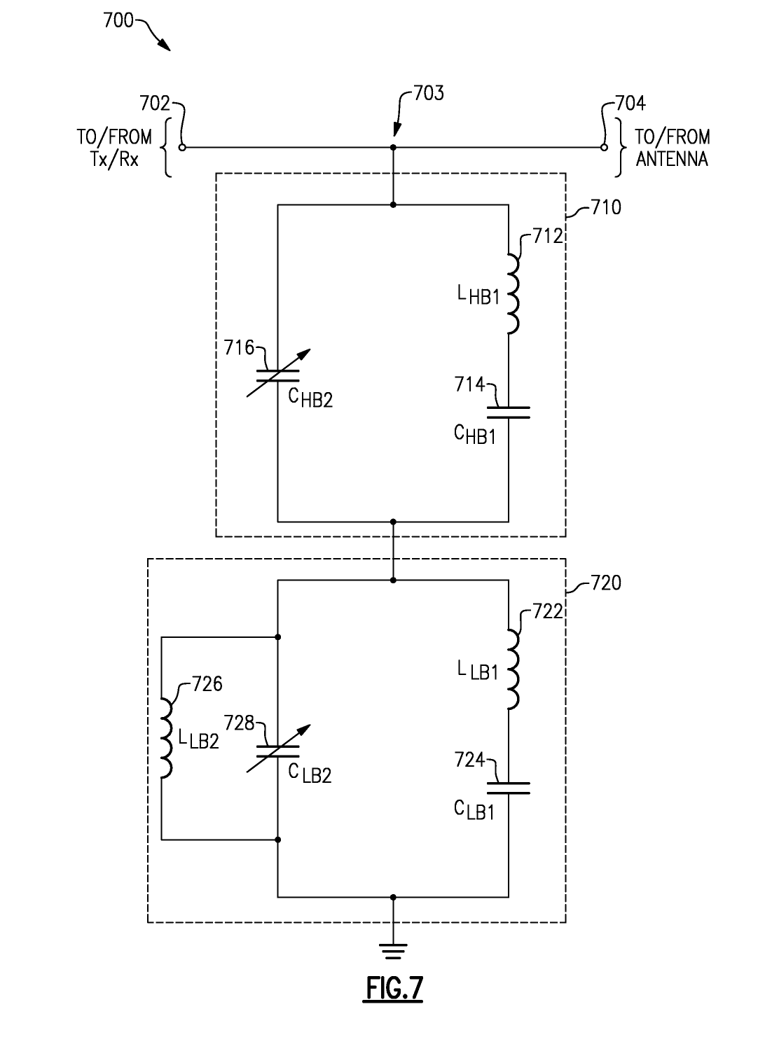

To that end, the wireless device 300 includes the dual-band antenna tuner circuit 360 paired with a dual-band antenna 370. The dual-band antenna tuner circuit 360 is configured to enable independent tuning of HB and LB transmission bands associated with a dual-band antenna 370. In some implementations, the dual-band antenna tuner circuit 360 includes at least one of a series tuner circuit 361 and a shunt tuner circuit 362. An example of a series tuner circuit in accordance with some implementations is described in greater detail below with reference to FIGS. 5 and 6. An example of shunt tuner circuit in accordance with some implementations is described in greater detail below with reference to FIG. 7. An example of a tuner circuit including both series and shunt stages in accordance with some implementations is described below with reference to FIG. 8.

As shown in FIG. 3, in some implementations, the dual-band antenna tuner circuit 360 is coupled to HB and LB transmission signal paths through a HB/LB diplexer 350. In some implementations, the HB/LB diplexer 350 is configured to provide additional and optional frequency domain isolation between RF signals transmitted and/or received in the HB transmission band, and RF signals transmitted and/or received in the LB transmission band. However, unlike an antenna switch, the HB/LB diplexer 350 allows both the HB and LB transceivers 120, 130 to be simultaneously operably coupled to the dual-band antenna 370 through the dual-band antenna tuner circuit 360.

That is, both the HB and LB transceivers 120, 130 are simultaneously operably coupled to the dual-band antenna 370 through the dual-band antenna tuner circuit 360, the HB/LB diplexer 350, and the respective HB and LB duplexers 141, 143. An antenna switch is not required to prevent simultaneous coupling as described above because the dual-band antenna tuner circuit 360 is operable to simultaneously and independently tune HB and LB transmission bands. That is, the dual-band antenna tuner circuit 360 is operable to simultaneously provide a first impedance match at a first frequency for a HB transmission band and provide a second impedance match at a second frequency for a LB transmission band without the restriction of the impedance matches having a correlated frequency-dependence.

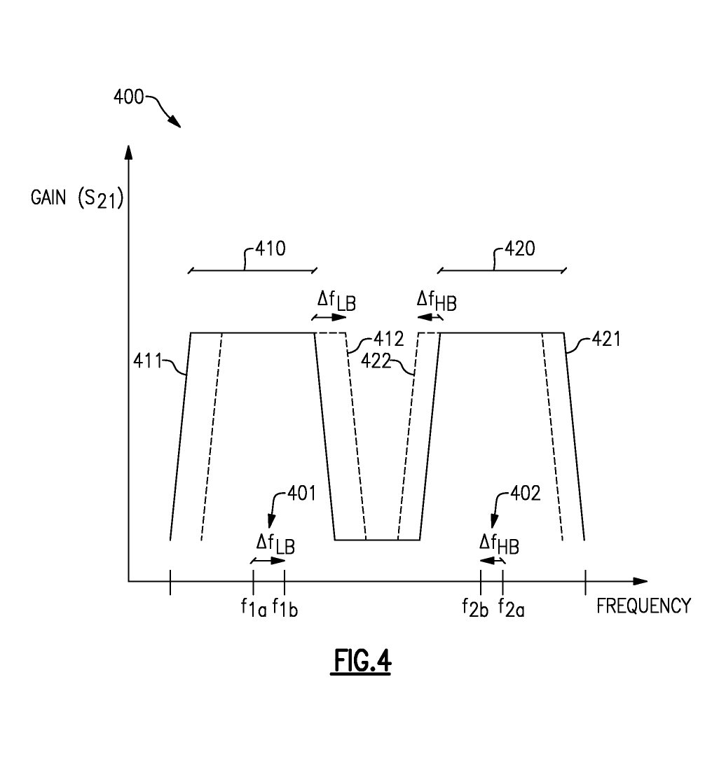

FIG. 4 is a performance diagram 400 illustrating an example of simultaneous and independent tuning on two transmission bands 410 and 420 enabled by a dual-band antenna tuner circuit in accordance with some implementations. More specifically, the performance diagram 400 is an approximation of forward transmission coefficient (i.e., s-parameter s21) performance in the frequency domain of a dual-band antenna paired with dual-band antenna tuner circuit in accordance with some implementations. The dual-band antenna tuner circuit and the dual-band antenna establish first and second transmission bands 410, 420, in which the antenna load impedance (Zₐₙₜₑₙₙₐ) is independently matched to corresponding first and second transceiver paths operable in different frequency bands.

The first transmission band 410 is located at a respective first position 411 around a corresponding first center frequency f₁ₐ. Similarly, the second transmission band 420 is located at a respective first position 421 around a corresponding first center frequency f₂ₐ. In some implementations, a dual-band antenna tuner circuit is capable of tuning each transmission band 410, 420 so that a respective impedance match provided in one band (e.g., band 410) is tuned independently of a respective impedance match simultaneously provided in another band (e.g., band 420). As a result, tuning the first transmission band 410 from the first position 411 to a second position 412 by a frequency shift (Δf_{LB}) 401 does not result in a simultaneous frequency shift of the second transmission band 420. Tuning of the second transmission band 420 does not have to occur at all. Or, if tuning is desirable, tuning of the second transmission band 420 from the first position 441 to a second position 442 by a frequency shift (Δf_{HB}) 402 does not result in a simultaneous frequency shift of the first transmission band 410. Merely as an example provided in order to emphasize the tuning independence between the bands 410, 420, FIG. 4 shows that the frequency shift (Δf_{LB}) 401 of the lower transmission band 410 is in the opposite direction of and is of a larger magnitude as compared to the frequency shift (Δf_{HB}) 402 of the higher transmission band 420. As such, tuning in one band is decoupled from tuning in the other band without the use of an antenna switch, which in turn enables simultaneous use of both transmission bands 410, 420.

FIG. 5 is a schematic diagram of a series dual-band antenna tuner arrangement 500 in accordance with some implementations. While certain specific features are illustrated, those skilled in the art will appreciate from the present disclosure that various other features have not been illustrated for the sake of brevity and so as not to obscure more pertinent aspects of the example implementations disclosed herein. To that end, the tuner arrangement 500 includes a first tunable two-terminal circuit 510 and a second tunable two-terminal circuit 520 coupled in parallel between a first node 501 and a second node 504.

The first tunable two-terminal circuit 510 includes resonant tank circuit in series with a tunable inductance. In some implementations, the resonant tank circuit includes a first inductor (L_{HB1}) 512 and a first capacitor (C_{HB1}) 514 coupled in parallel. As shown in FIG. 5, in some implementations, the tunable inductance includes a second inductor (L_{HB2}) 516 and a tunable capacitor (C_{HB2}) 518. As described below with reference to FIG. 6 in more detail, in operation, the first tunable two-terminal circuit 510 provides a low transmission impedance associated with a first frequency band, and a high transmission impedance associated with a second frequency band. Additionally, the tunable capacitor (C_{HB2}) 518 serving as a first control element is operable to selectively adjust a first resonant frequency associated with the first frequency band. In some implementations, the tunable capacitor (C_{HB2}) 518 is responsive to a first control signal in order to selectively adjust a first resonant frequency associated with the first frequency band.

The second tunable two-terminal circuit 520 includes a tunable capacitor (C_{LB1}) 522 in series with a resonant tank circuit. In some implementations, the resonant tank circuit includes an inductor (L_{LB1}) 526 and a capacitor (C_{LB2}) 524 coupled in parallel. As described below with reference to FIG. 6 in more detail, in operation, the second tunable two-terminal circuit 520 provides a high transmission impedance associated with a first frequency band, and a low transmission impedance associated with a second frequency band. Additionally, the tunable capacitor (C_{LB1}) 522 serving as a second control element is operable to selectively adjust a second resonant frequency associated with the second frequency band. In some implementations, the tunable capacitor (C_{LB1}) 522 is responsive to a second control signal in order to selectively adjust a second resonant frequency associated with the second frequency band.

In some implementations, the first frequency band occupies a frequency range greater than the second frequency band. In some implementations, the second frequency band occupies a frequency range greater than the first frequency band.

FIG. 6A is a performance diagram 600a showing complementary impedance poles and zeros of the dual-band antenna tuner arrangement 500 of FIG. 5, in accordance with some implementations, when the first frequency band occupies a frequency range greater than the second frequency band. More specifically, in operation, the first tunable two-terminal circuit 510 is characterized by a first impedance performance curve 611 and the second tunable two-terminal circuit 520 is characterized by a second impedance performance curve 621. The first impedance performance curve 611 includes a first impedance-zero 602 in the first frequency band, and a first impedance-pole 601 in the second frequency band. The second impedance performance curve 621 includes a second impedance-zero 603 in the second frequency band proximate to the first impedance-pole 601; and, a second impedance-pole 604 in the first frequency band proximate to the first impedance-zero 602. The result is that the first tunable two-terminal circuit 510 permits signal transmission in the first frequency band and substantially attenuates signal transmission in the second frequency band. Similarly, the second tunable two-terminal circuit 520 permits signal transmission in the second frequency band and substantially attenuates signal transmission in the first frequency band. More generally, in some implementations, the first tunable two-terminal circuit 510 includes an impedance-zero 602 in the first frequency band, and the second tunable two-terminal circuit 520 includes an impedance-pole 604 in the first frequency band proximate to the impedance-zero 602.

In operation, with reference to FIGS. 5 and 6A, tuning in the first frequency band is accomplished by adjustment of capacitor (C_{HB2}) 518 in the first tunable two-terminal circuit 510. If no impedance matching is needed (e.g., a source coupled to node 502 and a load coupled to node 504 are already matched in the first frequency band), capacitor (C_{HB2}) 518 is tuned until the impedance of path 510 is substantially zero in the first frequency band, meaning the impedance-zero 602 in FIG. 6 is adjusted to fall substantially on the desired frequency. If it is desired that the first tunable two-terminal circuit 510 provide a net series capacitance, then capacitor (C_{HB2}) 518 is decreased. If it is desired that the first tunable two-terminal circuit 510 provide a net series inductance, then capacitor (C_{HB2}) 518 is increased. The second tunable two-terminal circuit 520 has substantially no influence on the result, because it exhibits a substantially infinite impedance in the first frequency band.

Similarly, tuning in the second frequency band is accomplished by adjustment of capacitor (C_{LB2}) 522 in the second tunable two-terminal circuit 520. If no impedance matching is needed (e.g., a source coupled to node 502 and a load coupled to node 504 are already matched in the second frequency band), capacitor (C_{LB2}) 522 is tuned until the impedance of second tunable two-terminal circuit 520 is substantially zero in the second frequency band, meaning the impedance-zero 603 in FIG. 6 is adjusted to fall substantially on the desired frequency. If it is desired that the second tunable two-terminal circuit 520 provide a net series capacitance, then capacitor (C_{LB2}) 522 is decreased. If it is desired that the second tunable two-terminal circuit 520 provide a net series inductance, then capacitor (C_{LB2}) 522 is increased. The first tunable two-terminal circuit 510 has no influence on the result, because it exhibits a substantially infinite impedance in the second frequency band.

FIG. 7 is a schematic diagram of a shunt dual-band antenna tuner arrangement 700 in accordance with some implementations. Again, while certain specific features are illustrated, those skilled in the art will appreciate from the present disclosure that various other features have not been illustrated for the sake of brevity and so as not to obscure more pertinent aspects of the example implementations disclosed herein. To that end, the tuner arrangement 700 includes a first tunable two-terminal circuit 710 and a second tunable two-terminal circuit 720 coupled in series between first and second nodes. As shown in FIG. 7, the first node is electrical ground and the second node is a connection 703 to a transmission path characterized by end-points 702, 704.

The first tunable two-terminal circuit 710 includes a resonant tank circuit with first and second branches. The first branch includes a tunable capacitor (C_{HB2}) 716. The second branch includes an inductor (L_{HB1}) 712 and a capacitor (C_{HB1}) 714 coupled in series. With reference to FIG. 6B, the first tunable two-terminal circuit 710 provides a high impedance associated with a first frequency band, and a low impedance associated with a second frequency band. Additionally, the tunable capacitor (C_{HB2}) 716 serving as a first control element is operable to selectively adjust a first resonant frequency associated with the first frequency band. In some implementations, the tunable capacitor (C_{HB2}) 716 is responsive to a first control signal in order to selectively adjust a first resonant frequency associated with the first frequency band.

The second tunable two-terminal circuit 720 also includes a resonant tank with first and second branches. The first branch includes a first inductor (L_{LB1}) 512 and a first capacitor (C_{LB1}) 514 coupled in series. The second branch includes a tunable inductance. As shown in FIG. 7, in some implementations, the tunable inductance includes a second inductor (L_{LB2}) 726 and a tunable capacitor (C_{LB2}) 728. With reference to FIG. 6B, the second tunable two-terminal circuit 720 provides a low impedance associated with a first frequency band, and a high impedance associated with a second frequency band. Additionally, the tunable capacitor (C_{LB2}) 728 serving as a second control element is operable to selectively adjust a second resonant frequency associated with the second frequency band. In some implementations, the tunable capacitor (C_{LB2}) 728 is responsive to a second control signal in order to selectively adjust a second resonant frequency associated with the second frequency band.

FIG. 6B is a performance diagram 600b showing complementary impedance poles and zeros of the dual-band antenna tuner arrangement 700 of FIG. 7, in accordance with some implementations, when the first frequency band occupies a frequency range greater than the second frequency band. More specifically, in operation, the first tunable two-terminal circuit 710 is characterized by a first impedance performance curve 671 and the second tunable two-terminal circuit 720 is characterized by a second impedance performance curve 661. The first impedance performance curve 671 includes a first impedance-zero 653 in the first frequency band, and a first impedance-pole 654 in the second frequency band. The second impedance performance curve 661 includes a second impedance-zero 652 in the second frequency band proximate to the first impedance-pole 654; and, a second impedance-pole 651 in the first frequency band proximate to the first impedance-zero 653. The result is that the first tunable two-terminal circuit 710 permits signal transmission in the first frequency band and substantially attenuates signal transmission in the second frequency band. Similarly, the second tunable two-terminal circuit 720 permits signal transmission in the second frequency band and substantially attenuates signal transmission in the first frequency band.

In operation, with reference to FIGS. 7 and 6B, tuning in the first frequency band is accomplished by adjustment of capacitor (C_{HB2}) 716 in the first tunable two-terminal circuit 710. If no impedance matching is needed (e.g., a source coupled to node 702 and a load coupled to node 704 are already matched in the first frequency band), capacitor (C_{HB2}) 716 is tuned until it presents a substantially infinite in the first frequency band, meaning the impedance-pole 654 in FIG. 6B is adjusted to fall substantially on the desired frequency. If it is desired that the first tunable two-terminal circuit 710 provide a net shunt capacitance, then capacitor (C_{HB2}) 716 is increased. If it is desired that the first tunable two-terminal circuit 710 provide a net shunt inductance, then capacitor (C_{HB2}) 716 is decreased. The second tunable two-terminal circuit 720 has no influence on the result, because it exhibits a substantially zero impedance in the first frequency band.

Similarly, tuning in the second frequency band is accomplished by adjustment of capacitor (C_{LB2}) 728 in the second tunable two-terminal circuit 720. If no impedance matching is needed (e.g., a source coupled to node 702 and a load coupled to node 704 are already matched in the second frequency band), capacitor (C_{LB2}) 728 is tuned until the impedance of the second tunable two-terminal circuit 720 is substantially infinite in the second frequency band, meaning the impedance-pole 651 in FIG. 6B is adjusted to fall substantially on the desired frequency. If it is desired that the second tunable two-terminal circuit 720 provide a net shunt capacitance, then capacitor (C_{LB2}) 728 is increased. If it is desired that the second tunable two-terminal circuit 720 provide a net shunt inductance, then capacitor (C_{LB2}) 728 is decreased. The first tunable two-terminal circuit 710 has no influence on the result, because it exhibits a substantially zero impedance in the second frequency band.

FIG. 8 is a block diagram of a dual-band antenna tuner arrangement 800 in accordance with some implementations. Again, while certain specific features are illustrated, those skilled in the art will appreciate from the present disclosure that various other features have not been illustrated for the sake of brevity and so as not to obscure more pertinent aspects of the example implementations disclosed herein. To that end, the dual-band tuner arrangement 800 includes one or more series tuner circuits and one or more shunt tuner circuits arranged between first and second nodes 802, 804. More specifically, as shown in FIG. 800, as an example, the dual-band antenna tuner arrangement 800 includes first and second series tuner circuits 500a, 500b arranged in series between the first and second nodes 802,804. The dual-band antenna tuner arrangement 800 also includes, and first and second shunt tuner circuits 700a, 700b. The first shunt tuner circuit 700a is coupled between the first and second series tuner circuits 500a, 500b and ground. The second shunt tuner circuit 700b is coupled between the second node 804 and ground.

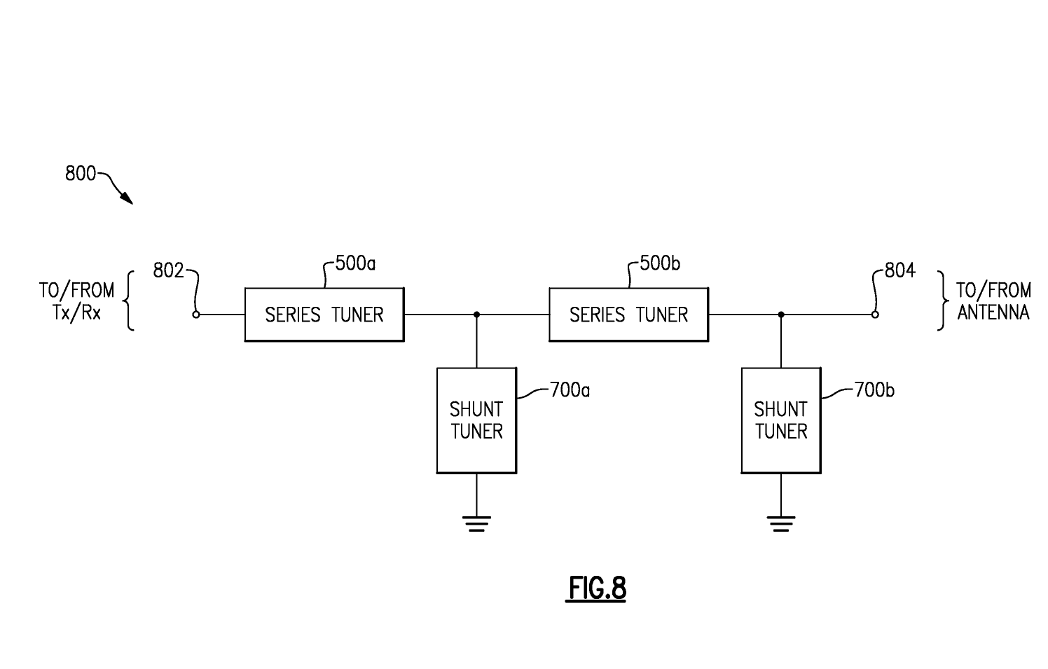

FIG. 9 is a block diagram of a dual-band antenna tuner system 900 in accordance with some implementations. The dual-band antenna tuner system 900 illustrated in FIG. 9 is similar to and adapted from the wireless device 300b illustrated in FIG. 3B. Elements common to FIG. 3B and FIG. 9 include common reference numbers, and only the differences between FIG. 3B and FIG. 9 are described herein for the sake of brevity. Again, while certain specific features are illustrated, those skilled in the art will appreciate from the present disclosure that various other features have not been illustrated for the sake of brevity and so as not to obscure more pertinent aspects of the example implementations disclosed herein.

To that end, the dual-band antenna tuner system 900 includes an implementation of the dual-band antenna tuner arrangement 500 in place of the tuner circuit module 360. Additionally, the dual-band antenna tuner system 900 also includes one or more processing units (CPU's) 902, one or more output interfaces 903, a memory 906, a programming interface 908, and one or more communication buses 904 for interconnecting these and various other components.

In some implementations, the communication buses 904 include circuitry that interconnects and controls communications between system components. The memory 906 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 906 optionally includes one or more storage devices remotely located from the CPU(s) 902. The memory 906 comprises a non-transitory computer readable storage medium. Moreover, in some implementations, the memory 906 or the non-transitory computer readable storage medium of the memory 906 stores the following programs, modules and data structures, or a subset thereof including an optional operating system 930, and a tuning module 940.

The operating system 930 includes procedures for handling various basic system services and for performing hardware dependent tasks.

In some implementations, with additional reference to FIG. 5, the tuning module 940 is configured to provide first and second control signals in order to effectuate independent tuning of the first and second two-terminal circuits 510, 520 of the tuner 500 [or tuners 700, 800]. To that end, the tuning module 940 includes a HB tuning module 941 and a LB tuning module 943. The HB tuning module 941 is configured to selectively adjust a first resonant frequency associated with the first frequency band by providing a first control signal to the tunable capacitor (C_{HB2}) 518. To that end, the HB tuning module 941 includes a set of instructions 941a, and heuristics and metadata 941b. Similarly, the LB tuning module 943 is configured to selectively adjust a second resonant frequency associated with the second frequency band by providing a first control signal to the tunable capacitor (C_{LB1}) 522. To that end, the LB tuning module 943 includes a set of instructions 941a, and heuristics and metadata 941b.

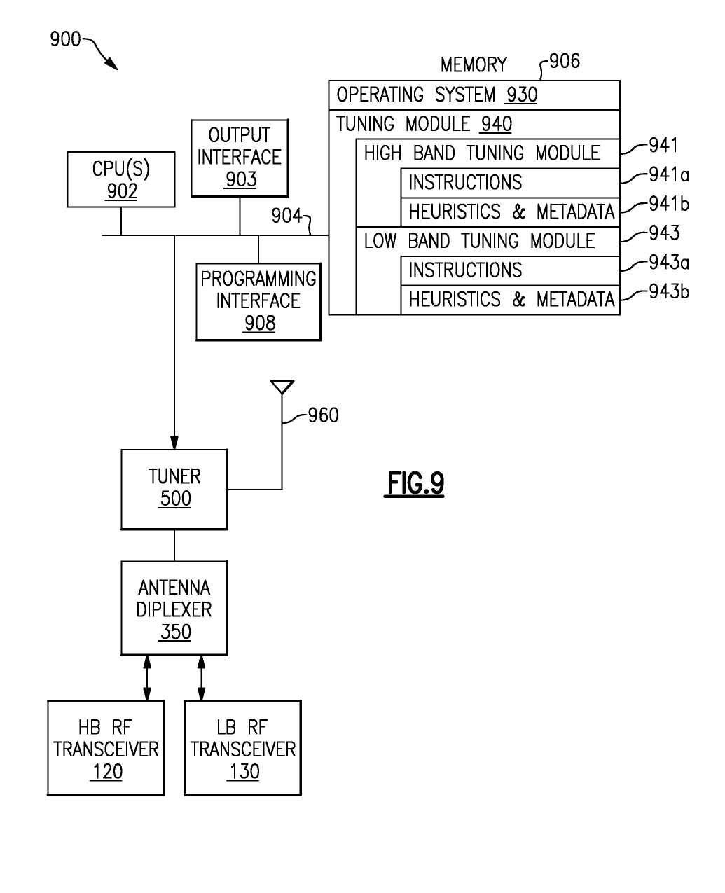

FIGS. 10A-10C are schematic diagrams of integrated circuits including implementations of at least one of dual-band antenna tuner arrangements 500, 700, 800 in accordance with some implementations. While some example features are illustrated, those skilled in the art will appreciate from the present disclosure that various other features have not been illustrated for the sake of brevity and so as not to obscure more pertinent aspects of the example implementations disclosed herein. To that end, for example, FIG. 10A shows that in some implementations, some or all portions of the dual-band antenna tuner arrangement 500 can be part of a semiconductor die 1000. By way of an example, the dual-band antenna tuner arrangement 500 can be formed on a substrate 1002 of the die 1000. A plurality of connection pads 1004 can also be formed on the substrate 1002 to facilitate functionalities associated with some or all portions of the dual-band antenna tuner arrangement 500.

FIG. 10B shows that in some implementations, a semiconductor die 1000 having a substrate 1002 can include some or all portions of the antenna diplexer 350 (of FIG. 3B) and some or all portions of the dual-band antenna tuner arrangement 500 of FIG. 5. A plurality of connection pads 1004 can also be formed on the substrate 1002 to facilitate functionalities associated with some or all portions of the antenna diplexer 350 and some or all portions of the dual-band antenna tuner arrangement 500.

FIG. 10C shows that in some embodiments, a semiconductor die 1000 having a substrate 1002 can include some or all portions of the HB transceiver 120 (of FIG. 3B), some or all portions of the LB transceiver 130 (of FIG. 3B), some or all portions of the antenna diplexer 350, and some or all portions of the dual-band antenna tuner arrangement 500. A plurality of connection pads 1004 can also be formed on the substrate 1002 to facilitate functionalities associated with some or all portions of the HB transceiver 120, the LB transceiver 130, the antenna diplexer 350, and the dual-band antenna tuner arrangement 500.

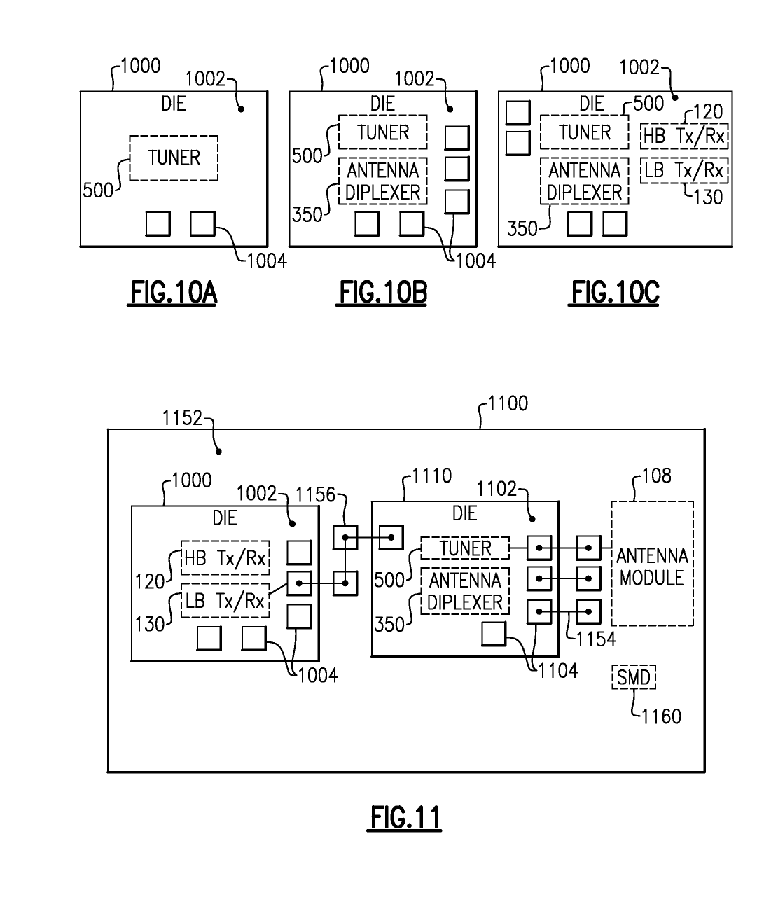

In some implementations, one or more features described herein can be included in a module. For example, FIG. 11 is a schematic diagram of a module 1100 including the dual-band antenna tuner arrangements 500, 700, 800 in accordance with some implementations. While some example features are illustrated, those skilled in the art will appreciate from the present disclosure that various other features have not been illustrated for the sake of brevity and so as not to obscure more pertinent aspects of the example implementations disclosed herein. The module 1100 includes a packaging substrate 1152, connection pads 1156, a first die 1000, a second die 1110, and one or more surface mount devices 1160.

The first die 1000 includes a substrate 1002 including some or all portions of the HB transceiver 120, and some or all portions of the LB transceiver 130 of FIG. 3B. A plurality of connection pads 1004 is formed on the substrate 1002 to facilitate functionalities associated with some or all portions of the HB transceiver 120, and some or all portions of the LB transceiver 130. The second die 1110 includes a substrate 1102 including some or all portions of the antenna diplexer 350 and some or all portions of the dual-band antenna tuner arrangement 500. The second die 1110 also includes a plurality of connection pads 1004 formed on the substrate 1102 to facilitate functionalities associated with some or all portions of the antenna diplexer 350, and the dual-band antenna tuner arrangement 500.

In some implementations, the components mounted on the packaging substrate 1152 or formed on or in the packaging substrate 1152 can further include, for example, one or more surface mount devices (SMDs) (e.g., 1160) and one or more matching networks (e.g., 108). In some embodiments, the packaging substrate 1152 can include a laminate substrate.

In some implementations, the module 1100 can also include one or more packaging structures to, for example, provide protection and facilitate easier handling of the module 1100. Such a packaging structure can include an overmold formed over the packaging substrate 1152 and dimensioned to substantially encapsulate the various circuits and components thereon.

It will be understood that although the module 1150 is described in the context of wirebond-based electrical connections, one or more features of the present disclosure can also be implemented in other packaging configurations, including flip-chip configurations.

In some implementations, a device and/or a circuit having one or more features described herein can be included in an RF device such as a wireless device. Such a device and/or a circuit can be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, a wireless router, a wireless access point, a wireless base station, etc. That is, those skilled in the art will also appreciate from the present disclosure that in various implementations the tuning arrangement may be included in various devices, such as a computer, a laptop computer, a tablet device, a netbook, an internet kiosk, a personal digital assistant, an optical modem, a base station, a repeater, a wireless router, a mobile phone, a smartphone, a gaming device, a computer server, or any other computing device. In various implementations, such devices include one or more processors, one or more types of memory, a display and/or other user interface components such as a keyboard, a touch screen display, a mouse, a track-pad, a digital camera and/or any number of supplemental devices to add functionality.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A multi-band tuning arrangement comprising:
a first tunable two-terminal circuit having a low transmission impedance associated with a first frequency band, and a high transmission impedance associated with a second frequency band, the first tunable two-terminal circuit including a first control element provided to selectively adjust a first resonant frequency associated with the first frequency band; and
a second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

2. The multi-band tuning arrangement of claim 1 wherein the first control element is responsive to a first control signal, and the second control element is response to a second control signal.

3. The multi-band tuning arrangement of claim 1 wherein:
the first tunable two-terminal circuit includes a impedance-zero in the first frequency band; and
the second tunable two-terminal circuit includes an impedance-pole in the first frequency band proximate to the impedance-zero.

4. The multi-band tuning arrangement of claim 1 wherein:
the first tunable two-terminal circuit includes a first impedance-zero in the first frequency band, and a first impedance-pole in the second frequency band; and
the second tunable two-terminal circuit includes a second impedance-zero in the second frequency band proximate to the first impedance-pole, and a second impedance-pole in the first frequency band proximate to the first impedance-zero.

5. The multi-band tuning arrangement of claim 1 wherein the first and second tunable two-terminal circuits are coupled in parallel between first and second nodes.

6. The multi-band tuning arrangement of claim 5 wherein the first tunable two-terminal circuit includes resonant circuit in series with a tunable inductance.

7. The multi-band tuning arrangement of claim 6 wherein the tunable inductance includes an inductive element in series with a tunable capacitive element.

8. The multi-band tuning arrangement of claim 5 wherein the second tunable two-terminal circuit includes a tunable conductive element in series with a resonant circuit.

9. The multi-band tuning arrangement of claim 1 wherein the first frequency band occupies a frequency range greater than the second frequency band.

10. The multi-band tuning arrangement of claim 1 wherein the first and second tunable two-terminal circuits are coupled in series between first and second nodes, wherein the first node includes at least a portion of a transmission path.

11. The multi-band tuning arrangement of claim 10 wherein the first tunable two-terminal circuit includes a resonant tank with first and second branches, the first branch including a tunable capacitance.

12. The multi-band tuning arrangement of claim 10 wherein the second tunable two-terminal circuit includes a resonant tank with first and second branches, the first branch including a tunable inductance.

13. The multi-band tuning arrangement of claim 1 wherein the first tunable two-terminal circuit is connectable between a first port of a diplexer and an antenna port, and the second tunable two-terminal circuit is also connectable between the first port of the diplexer and the antenna port, and wherein a second port of the diplexer is connectable to a first transceiver, and a third port of the diplexer is connectable to the second transceiver port.

14. An multi-band tuning module comprising:
a packaging substrate configured to receive a plurality of components;
a first tunable two-terminal circuit at least partially arranged on the packaging substrate connectable between a first port of a diplexer and an antenna port, the first tunable two-terminal circuit having a low transmission impedance associated with a first frequency band, and a high transmission impedance associated with a second frequency band, the first tunable two-terminal circuit including a first control element provided to selectively adjust a first resonant frequency associated with the first frequency band; and
a second tunable two-terminal circuit at least partially arranged on the packing substrate connectable between the first port of the diplexer and the antenna port, the second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

15. The multi-band tuning module of claim 14 wherein the first control element is responsive to a first control signal, and the second control element is response to a second control signal.

16. The multi-band tuning module of claim 14 wherein:
the first tunable two-terminal circuit includes a first impedance-zero in the first frequency band, and a first impedance-pole in the second frequency band; and
the second tunable two-terminal circuit includes a second impedance-zero in the second frequency band proximate to the first impedance-pole, and a second impedance-pole in the first frequency band proximate to the first impedance-zero.

17. The multi-band tuning module of claim 14 wherein the first and second tunable two-terminal circuits are coupled in parallel between first and second nodes.

18. The multi-band tuning module of claim 14 wherein the first and second tunable two-terminal circuits are coupled in series between first and second nodes, wherein the first node includes at least a portion of a two-terminal circuit.

19. A wireless device comprising:
a multi-band antenna configured to transmit and receive radio frequency signals in a plurality of disjoint portions of frequency spectrum;
a first transceiver configured to at least one of transmit and receive radio frequency signals in a first frequency band of the plurality of disjoint portions of frequency spectrum;
a second transceiver configured to at least one of transmit and receive radio frequency signals in a second frequency band of the plurality of disjoint portions of frequency spectrum;
a first tunable two-terminal circuit having a low transmission impedance associated with the first frequency band, and a high transmission impedance associated with the second frequency band, the first tunable two-terminal circuit including a first control element provided to selectively adjust a first resonant frequency associated with the first frequency band; and
a second tunable two-terminal circuit having a high transmission impedance associated with the first frequency band, and a low transmission impedance associated with the second frequency band, the second tunable circuit including a second control element provided to selectively adjust a second resonant frequency associated with the second frequency band.

20. The wireless device of claim 19 wherein:
the first tunable two-terminal circuit includes a first impedance-zero in the first frequency band, and a first impedance-pole in the second frequency band; and
the second tunable two-terminal circuit includes a second impedance-zero in the second frequency band proximate to the first impedance-pole, and a second impedance-pole in the first frequency band proximate to the first impedance-zero.
